(19) United States
(12) Patent Application Publication
(10) Pub. No.: US 2019/0095913 A1
(43) Pub. Date: Mar. 28, 2019

(54) ONLINE TRANSACTION INFRASTRUCTURE AND PROCESSES

(71) Applicant: MASTERCARD INTERNATIONAL INCORPORATED, Purchase, NY (US)

(72) Inventors: Marc Van Puyveld, Bornem (BE); Iain Kedzlie, Beaconsfield (GB); Sagitha George, Middlesex (GB); Piero Macari, Esher (GB); David Plater Lloyd, Eastbourne (GB); Bambina Blagden, Kingston Upon Thames (GB); Chaten Oberoi-Morris, London (GB); Anushree Ashutosh Prabhune, Stamford (GB); Paul Connolly, Dublin (IE)

(73) Assignee: MASTERCARD INTERNATIONAL INCORPORATED, Purchase, NY (US)

(21) Appl. No.: 16/136,726

(22) Filed: Sep. 20, 2018

(30) Foreign Application Priority Data
Sep. 22, 2017 (GB) 1715375.0

(51) Int. Cl. G06Q 20/40; G06Q 20/24; G06Q 20/34; G06Q 40/02

(52) U.S. Cl. CPC G06Q 20/40; G06Q 40/02; G06Q 20/351; G06Q 20/24

(57) ABSTRACT

A method of authorizing payment for an online transaction according to a credit plan using a payment scheme infrastructure. A real and a virtual account number for a credit plan for a transaction are received from a credit issuer. The transaction is received for authorization from a merchant gateway—the transaction is completed for the virtual card number. The payment scheme infrastructure uses the virtual card number to obtain or confirm authorization for the credit plan, and recovers the real account number from the virtual card number to obtain authorization of the transaction from an issuer for the real account number. In this way the transaction is authorized if the credit plan is authorized and the transaction is authorized by the issuer for the real account number using suitable methods and apparatus at the payment scheme infrastructure, at the credit issuer computing system, and at the merchant computing system.

### TECHNICAL FIELD

The disclosure relates to an online transaction infrastructure and processes. In particular, it relates to a transaction infrastructure allowing new capabilities for online transactions between consumers and merchants and methods of staging and performing transactions using such an infrastructure.

### BACKGROUND

At present, online transactions are performed through transaction scheme providers (such as Mastercard, Visa and American Express) and through online payment providers (such as PayPal). Transactions using a transaction scheme provider typically use a four-party model—the customer uses a physical payment card associated with a customer account with an issuing bank, and the merchant receives funds from transactions in to a merchant account with an acquiring bank. The transaction scheme manages the performance of the transaction, including obtaining authorization as required from the issuing bank and arranging for clearing and settlement.

For online transactions, a payment gateway is used by a merchant to enable cardholder payment by use of a transaction scheme. Such payment gateways are typically provided by a payment service provider (PSP) with appropriate contractual, trust and technical relationships with merchants and banks.

FIGS. 1A to 1D illustrate performance of a transaction using a conventional payment card following the four-party model described above. As shown in FIG. 1A, the customer decides to make an online transaction using their physical payment card through their computing device (which may be a personal computer or laptop, or may be a mobile phone—or any other suitable computing device). The customer will work through the merchant's website to construct his or her order, and will then proceed to a payment scheme where they will indicate that the payment is to be made by credit card (for example). When the customer makes this decision the transaction details are forwarded to the merchant's PSP and any further customer verification required for an online transaction carried out. Transaction details are routed to the transaction provider, who seeks authorization for the transaction from the issuer bank.

If, as shown in FIG. 1C, the issuer bank approves the transaction, this is confirmed to the transaction infrastructure provider, who provides appropriate messaging to the merchant's PSP and so to the merchant and the customer's computing device. Authorization of the transaction allows the release of the goods to the consumer. In the later settlement phase, the issuer bank provides the payment amount debited from the customer's account to the acquirer bank, which credits the merchant account.

This model is effective, but it may not provide as full a range of payment options as the merchant may desire. In particular, the user is committed to making a full initial payment rather than a staged payment in instalments. Mechanisms for making instalment-based payments are available, but these will typically require significantly more setup than might be expected at an online store checkout.

### SUMMARY OF THE DISCLOSURE

In a first aspect, the disclosure provides a method of authorizing payment for an online transaction according to a credit plan using a payment scheme infrastructure, the method comprising at the payment scheme infrastructure: receiving from a credit issuer a real account number and a virtual account number for a credit plan for a transaction; receiving the transaction for authorization from a merchant gateway, wherein the transaction is completed for the virtual card number; using the virtual card number to obtain or confirm authorization for the credit plan, and recovering the real account number from the virtual card number to obtain authorization of the transaction from an issuer for the real account number; wherein the transaction is authorized if the credit plan is authorized and the transaction is authorized by the issuer for the real account number.

The transaction may further comprise an identifier in the transaction to indicate that it is associated with a credit plan, and the method further comprises using the identifier to identify the transaction as associated with a credit plan when it is received. The method may also further comprise further comprise checking eligibility for credit for the real account number when processing the transaction. The method may also further comprise further comprise providing an instalment code for the credit plan after successfully checking for eligibility for credit for the real account number.

In a second aspect, the disclosure provides a method of authorizing payment for an online transaction according to a credit plan using a payment scheme infrastructure, the method comprising a credit issuer: receiving from a customer a request for credit for a transaction together with customer information; determining whether to offer credit to the customer, and if so, providing a real account number for the customer and creating a virtual account number for a credit plan for the transaction; providing the virtual account number to the merchant and real account number and the virtual account number to the payment scheme infrastructure; authorizing the transaction, if the transaction is completed using the virtual account number and the credit plan is authorized, through an issuing bank associated with the credit issuer; and requesting payment from a customer for the transaction according to the credit plan.

If the customer has previously requested credit from the credit issuer, the credit issuer may then use the existing real account number for the customer but creates a new virtual card number for the credit plan.

In a third aspect, the disclosure provides a method of establishing and authorizing payment for an online transaction according to a credit plan using a payment scheme infrastructure, the method comprising a merchant: at an online checkout for a transaction, receiving a customer request for a credit plan for the transaction; causing the request for a credit plan and associated customer information to be provided to a credit issuer; if the request for a credit plan is accepted, receiving from the credit issuer a credit plan to present to the customer and a virtual card number for the credit plan; and if the customer accepts the credit plan, completing the transaction with the virtual card number and submitting the transaction for authorization.

Completing the transaction may further comprise including an identifier in the transaction to indicate that it is associated with a credit plan. The transaction may be completed with the virtual card number at a merchant payment gateway.

In a fourth aspect, the disclosure provides a payment scheme infrastructure adapted to authorize payment for an online transaction according to a credit plan, the payment scheme infrastructure being adapted to: receive from a credit issuer a real account number and a virtual account number for a credit plan for a transaction; on receiving a transaction for authorization from a merchant gateway completed for the virtual card number, to use the virtual card number to obtain or confirm authorization for the credit plan, and to recover the real account number from the virtual card number to obtain authorization of the transaction from an issuer for the real account number.

The payment scheme infrastructure may also comprise an eligibility checker for checking eligibility for credit for the real account number when processing the transaction. This eligibility checker may be adapted to obtain an instalment code for the credit plan after successfully checking for eligibility for credit for the real account number.

In a fifth aspect, the disclosure provides a credit issuer computing system adapted for authorizing payment for an online transaction according to a credit plan using a payment scheme infrastructure, the credit issuer computing system being adapted to: receive from a customer a request for credit for a transaction together with customer information; determine whether to offer credit to the customer, and if so, provide a real account number for the customer and create a virtual account number for a credit plan for the transaction; provide the virtual account number to the merchant and real account number and the virtual account number to the payment scheme infrastructure; authorize the transaction, if the transaction is completed using the virtual account number and the credit plan is authorized, through an issuing bank associated with the credit issuer; and request payment from a customer for the transaction according to the credit plan.

If the customer has previously requested credit from the credit issuer, the credit issuer computing system may be adapted to use the existing real account number for the customer but to create a new virtual card number for the credit plan.

In this way, the disclosure provides a transaction method in which a virtual card number is associated with a transaction credit plan, wherein the virtual card number is used to process the transaction through a payment card transaction infrastructure. The virtual card number may be associated with a real card number associated with a customer relationship with a merchant or credit facilitator. The real card number may be associated with multiple virtual card numbers, and these virtual card numbers may be associated with different transaction credit plans (with different payment terms).

In this way, the disclosure also provides a method of processing a transaction in a transaction infrastructure wherein a card number identifies a transaction as being associated with an instalment plan, and wherein the transaction is submitted for instalment plan approval before authorization of the transaction. This may be by obtaining an instalment code, which is then provided to an issuer bank for the transaction when authorization of the transaction is requested.

### BRIEF DESCRIPTION OF THE DRAWINGS

The scope of the present disclosure is best understood from the following detailed description of the exemplary embodiments when read in conjunction with the accompanying drawings. Included in the drawings are the following figures:

FIGS. 1A to 1D show an online transaction model using a conventional payment infrastructure as described above;

FIGS. 2A to 2I show an online transaction model using a payment infrastructure according to an embodiment of the disclosure;

FIGS. 3A to 3E show exemplary screens of a consumer computing device at particular stages of the model illustrated in FIGS. 2A to 2I;

FIG. 4 shows an alternative embodiment of an online transaction model using a payment infrastructure according to an embodiment of the disclosure;

FIG. 5 shows schematically a transaction system using the four-party model; and

FIG. 6 shows an implementation of the transaction system of FIG. 5 adapted for performing embodiments of the disclosure.

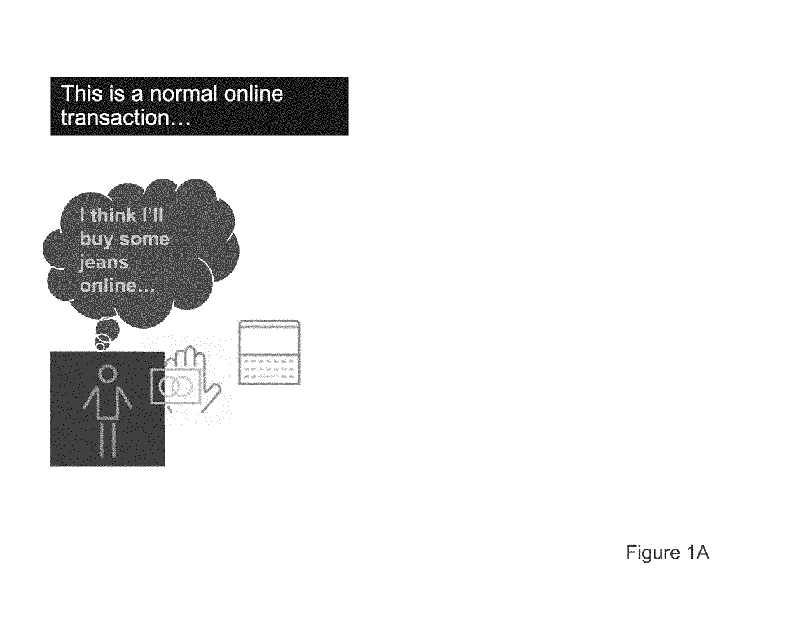

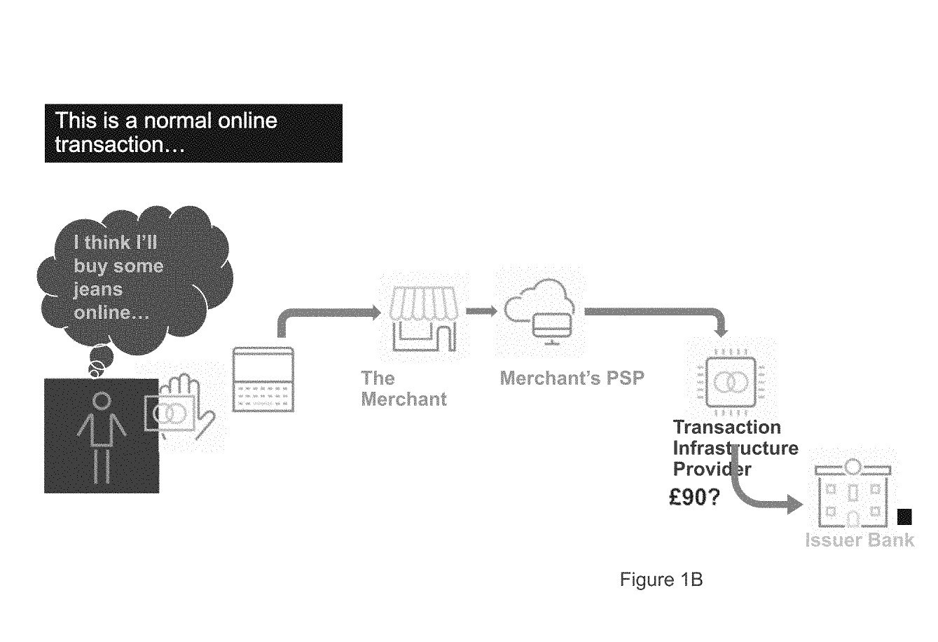

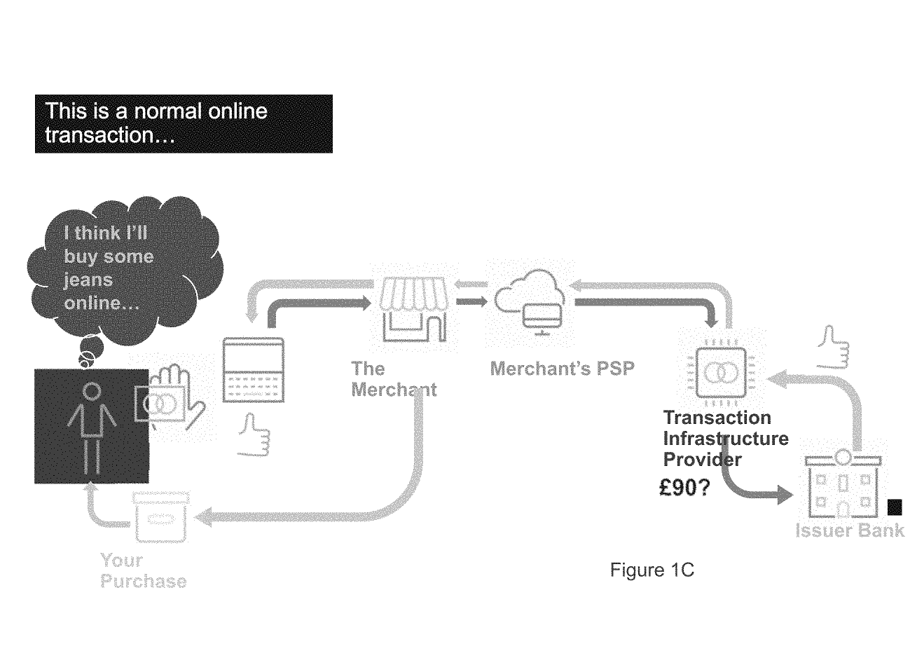

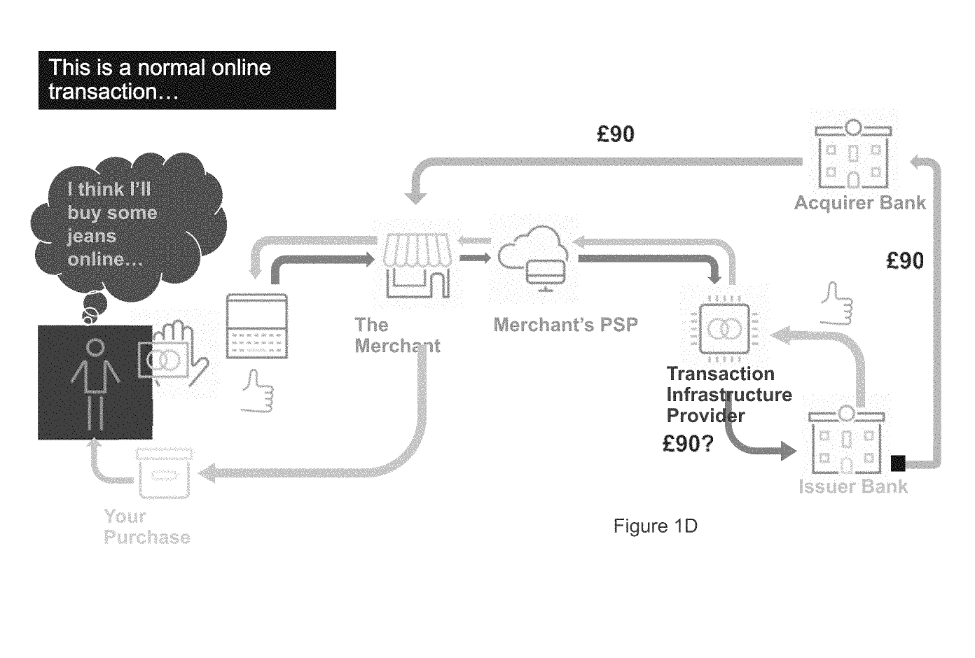

### DETAILED DESCRIPTION

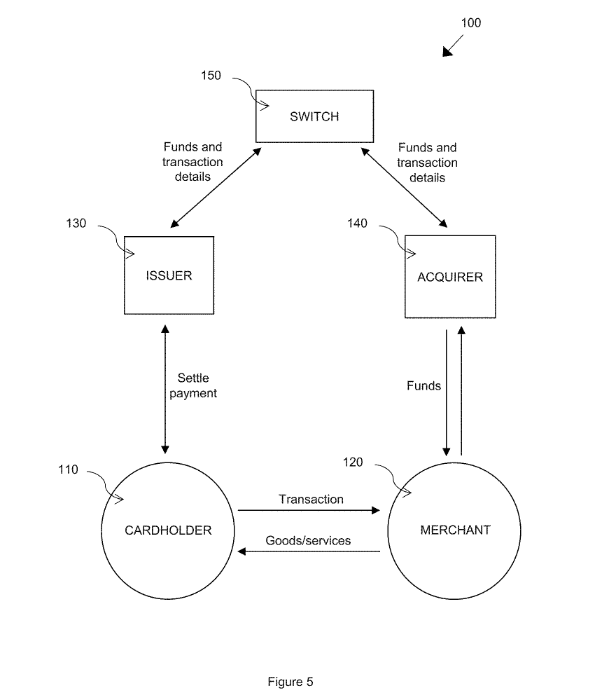

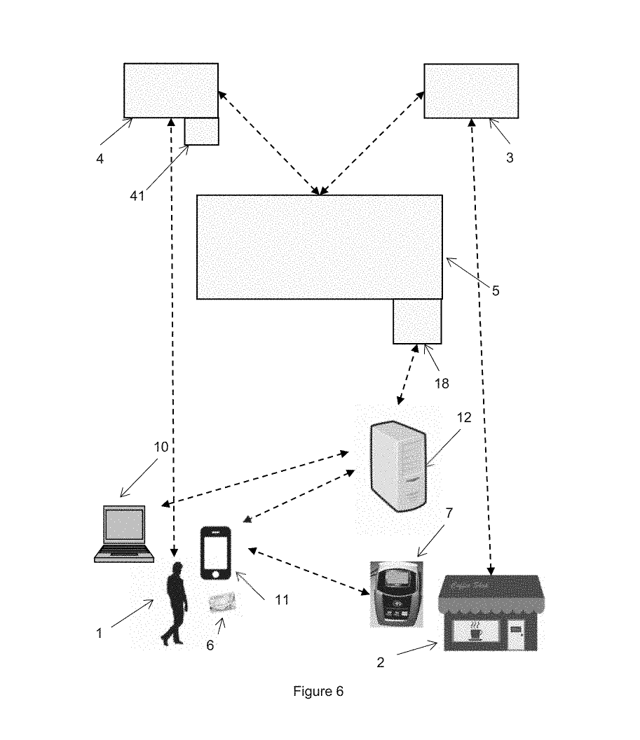

Before discussion of specific embodiments of the disclosure, the four-party transaction scheme model will be introduced with respect to FIG. 5 and an appropriate infrastructure for implementing a four-party transaction scheme, with modifications enabling support for specific embodiments of the disclosure, described in FIG. 6.

FIG. 5 is a block diagram of a typical four-party model or four-party payment transaction scheme. The diagram illustrates the entities present in the model and the interactions occurring between entities operating in a card scheme. Normally, card schemes—payment networks linked to payment cards—are based on one of two models: a three-party model or a four-party model (adopted by the present applicant). For the purposes of this document, the four-party model is described in further detail below.

The four-party model may be used as a basis for the transaction network. For each transaction, the model comprises four entity types: cardholder 110, merchant 120, issuer 130 and acquirer 140. In this model, the cardholder 110 purchases goods or services from the merchant 120. The issuer 130 is the bank or any other financial institution that issued the card to the cardholder 110. The acquirer 140 provides services for card processing to the merchant 120.

The model also comprises a central switch 150—interactions between the issuer 130 and the acquirer 140 are routed via the switch 150. The switch 150 enables a merchant 120 associated with one particular bank acquirer 140 to accept payment transactions from a cardholder 110 associated with a different bank issuer 130.

A typical transaction between the entities in the four-party model can be divided into two main stages: authorization and settlement. The cardholder 110 initiates a purchase of a good or service from the merchant 120 using their card. Details of the card and the transaction are sent to the issuer 130 via the acquirer 140 and the switch 150 to authorize the transaction. Should the transaction be considered abnormal by the issuer 130, the cardholder 110 may be required to undergo an additional verification process to verify their identity and the details of the transaction. Once the additional verification process is complete the transaction is authorized.

On completion of the transaction between the cardholder 110 and the merchant 120, the transaction details are submitted by the merchant 120 to the acquirer 140 for settlement.

The transaction details are then routed to the relevant issuer 130 by the acquirer 140 via the switch 150. Upon receipt of these transaction details, the issuer 130 provides the settlement funds to the switch 150, which in turn forwards these funds to the merchant 120 via the acquirer 140.

Separately, the issuer 130 and the cardholder 110 settle the payment amount between them. In return, a service fee is paid to the acquirer 140 by the merchant 120 for each transaction, and an interchange fee is paid to the issuer 130 by the acquirer 140 in return for the settlement of funds.

In practical implementations of a four-party system model, the roles of a specific party may involve multiple elements acting together. This is typically the case in implementations that have developed beyond a contact-based interaction between a customer card and a merchant terminal to digital implementations using proxy or virtual cards on user computing devices. As will be discussed further below, embodiments of the present disclosure relate to use of virtual cards in online transactions between a user computing device and a merchant server.

FIG. 8 shows an architecture according to an embodiment of the disclosure appropriate for interaction between a cardholder and a merchant, illustrating specifically how this is adapted to support an online transaction between a consumer device (a computing device used by a consumer to conduct online transactions) and a merchant server.

The cardholder 1 uses their computing device—which may be any or all of a cellular telephone handset, a tablet, a laptop, a static personal computer or any other suitable computing device (here both a cellular telephone handset 11 and a laptop computer 12 are shown as possible cardholder computing devices)—to provide user means for payment with a physical payment card 6 or as a virtual payment card operating only in a digital domain. The smartphone 11 may achieve this with a mobile payment application and a digital wallet (and can thus transact with a merchant POS terminal 7 using NFC or another contactless technology), but in the cases of relevance to the disclosure the cardholder computing device will typically be acting simply as a client interacting with a merchant server 12 representing the merchant 2 over any appropriate network connection, such as the public internet.

The transaction scheme infrastructure (transaction infrastructure, payment infrastructure, payment scheme infrastructure) 5 provides the computing infrastructure necessary to operate the card scheme and provide routing of transactions and other messaging to parties such as the acquirer 3 and the issuer 4—it may also provide services such as a wallet service to support a digital wallet on a cardholder computing device and a digital enablement service supporting tokenisation of transactions—these are not described in detail here but are discussed further in EMV specifications as identified below. Connecting to the transaction infrastructure 5 for performing online transactions there is an internet gateway 18 for a payment service provider to accept internet based transactions for processing by the transaction infrastructure 5.

Additional services may also be provided by the transaction infrastructure (as will be described below with reference to embodiments of the disclosure) and on behalf of other parties such as the issuer 4 and the acquirer 3. One such service is issuer permissioning service 41 which allows for configuration of card permissions—one example of such a service is the applicant's InControl service. As will be shown below, such a service is used in embodiments of the present disclosure.

Individual computing elements of the architecture of FIG. 7 may be essentially conventional—for example merchant server 12, which may be implemented by an industry standard server programmed to have a conventional server/client relationship with clients such as a merchant application on a user's smartphone. Similarly, the elements shown explicitly within the transaction scheme, which may be carried out by suitably programmed servers associated with the transaction scheme. Generally, the transaction scheme infrastructure 5 comprises servers, network communications and switches to allow transactions to be correctly routed and processed.

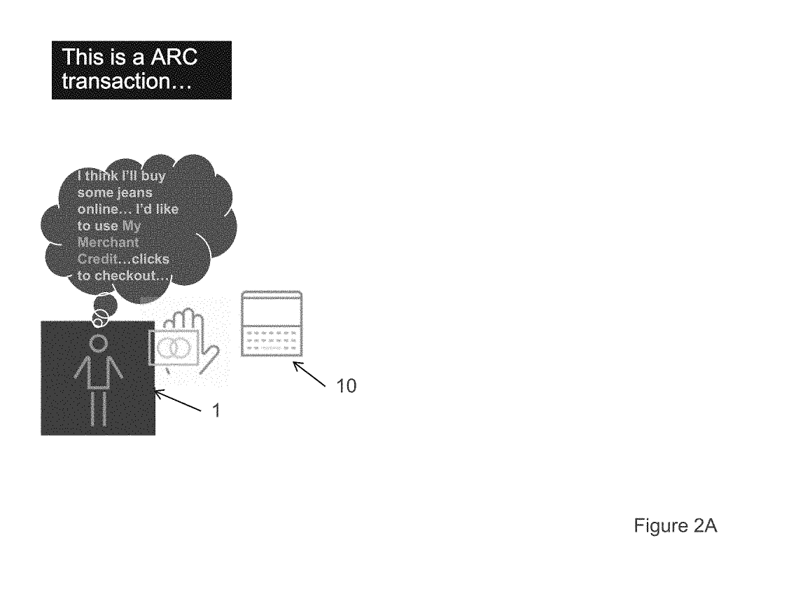

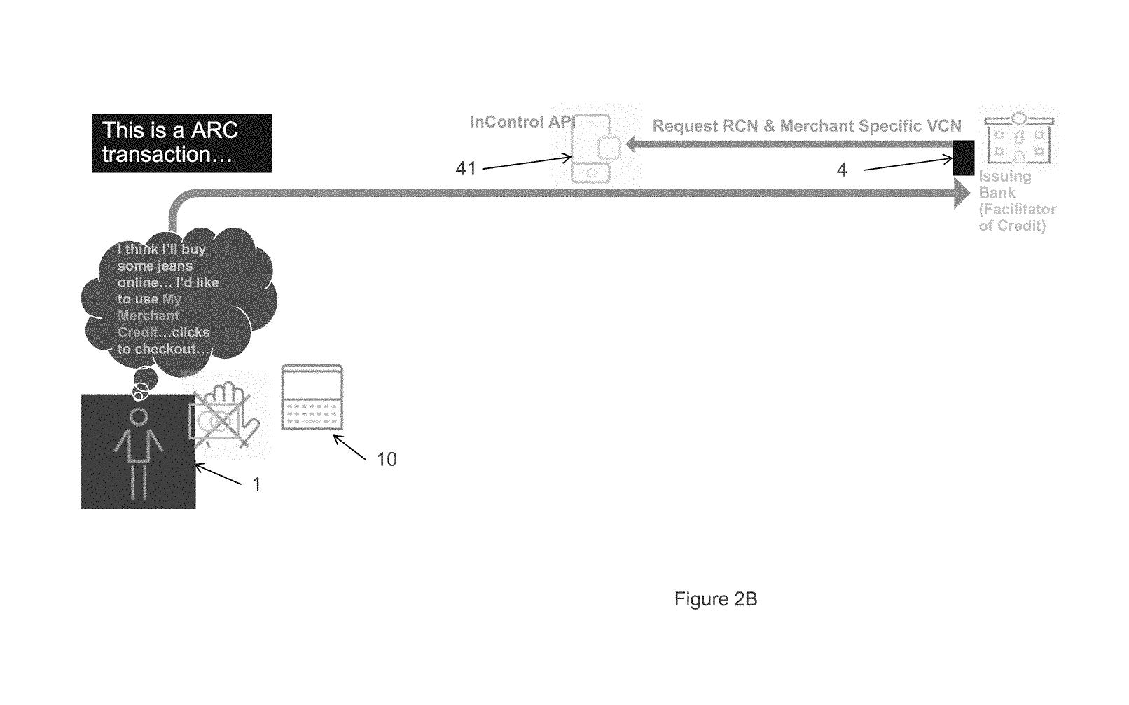

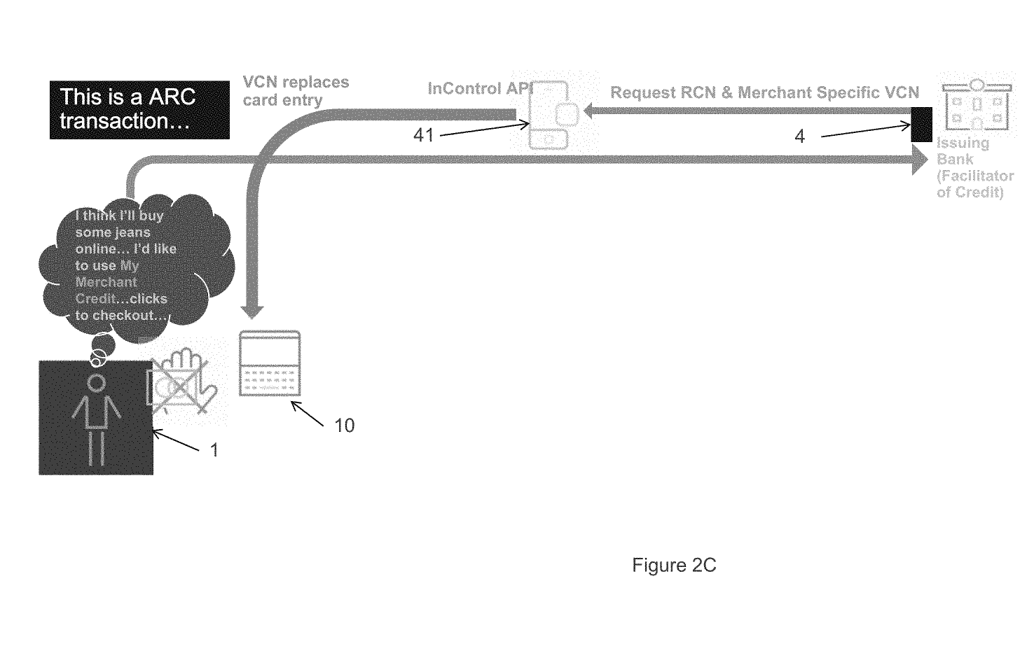

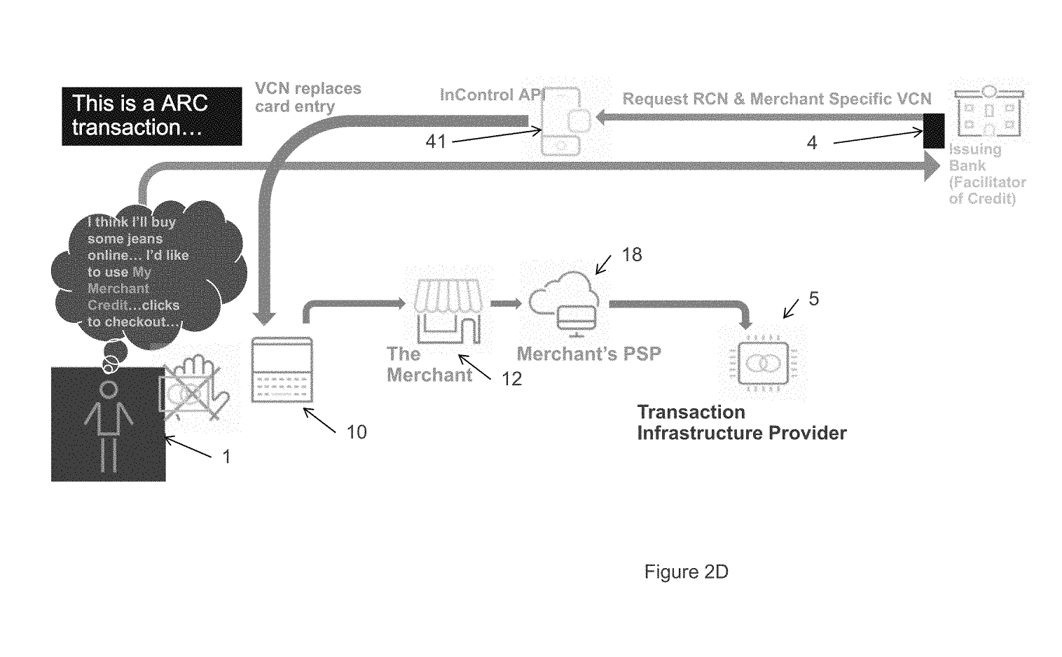

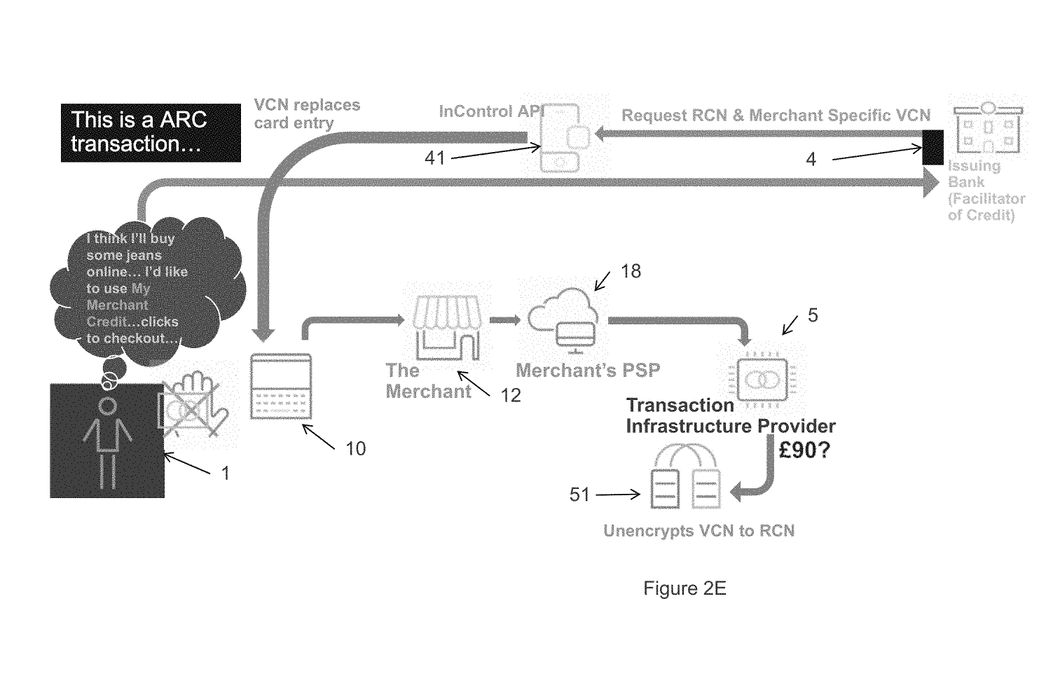

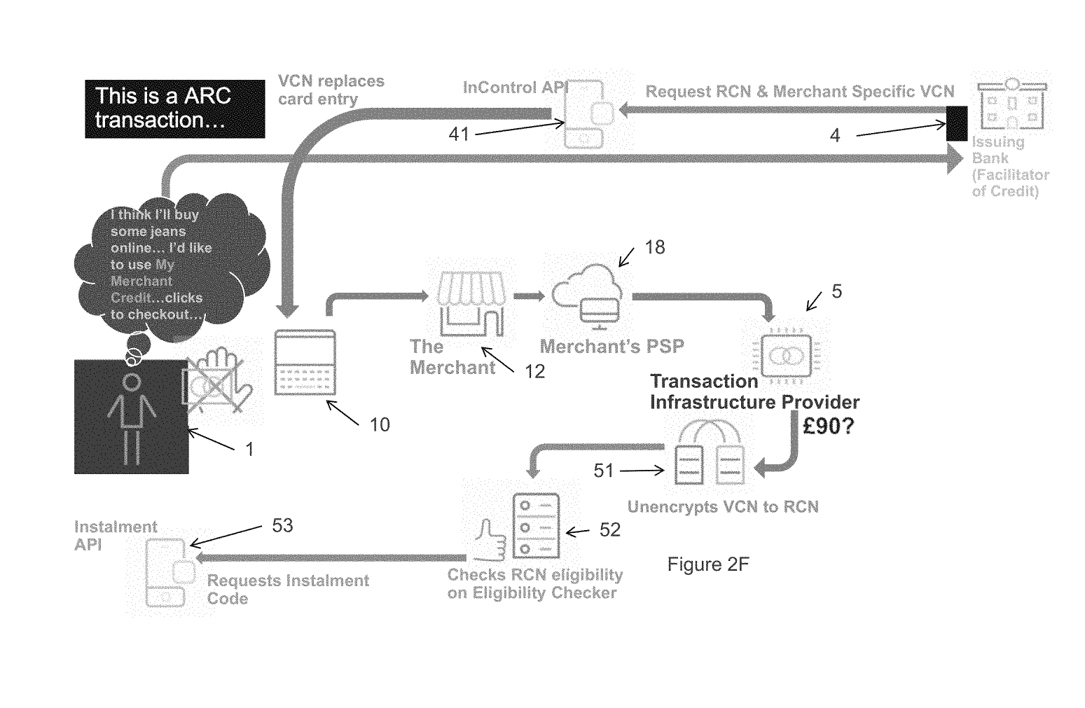

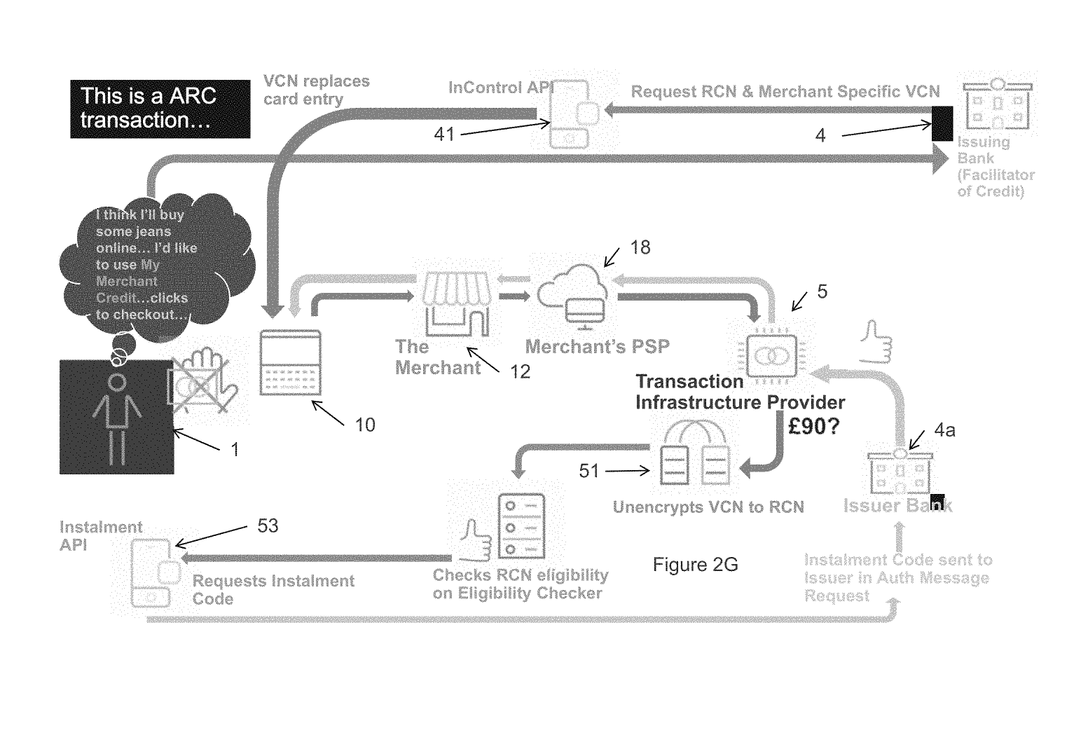

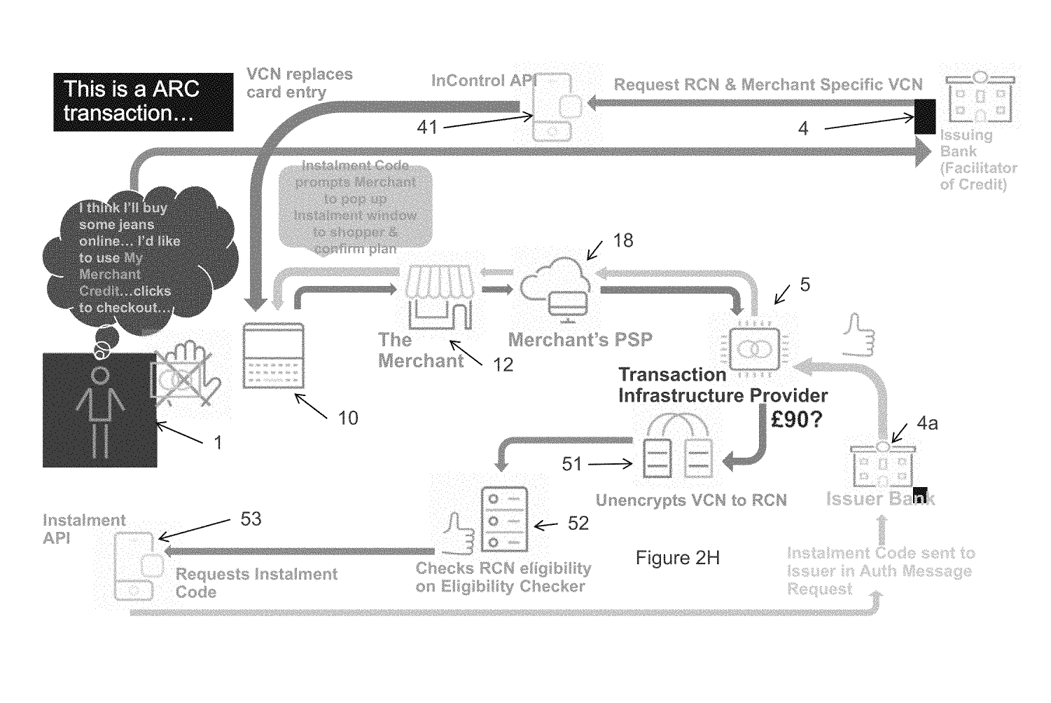

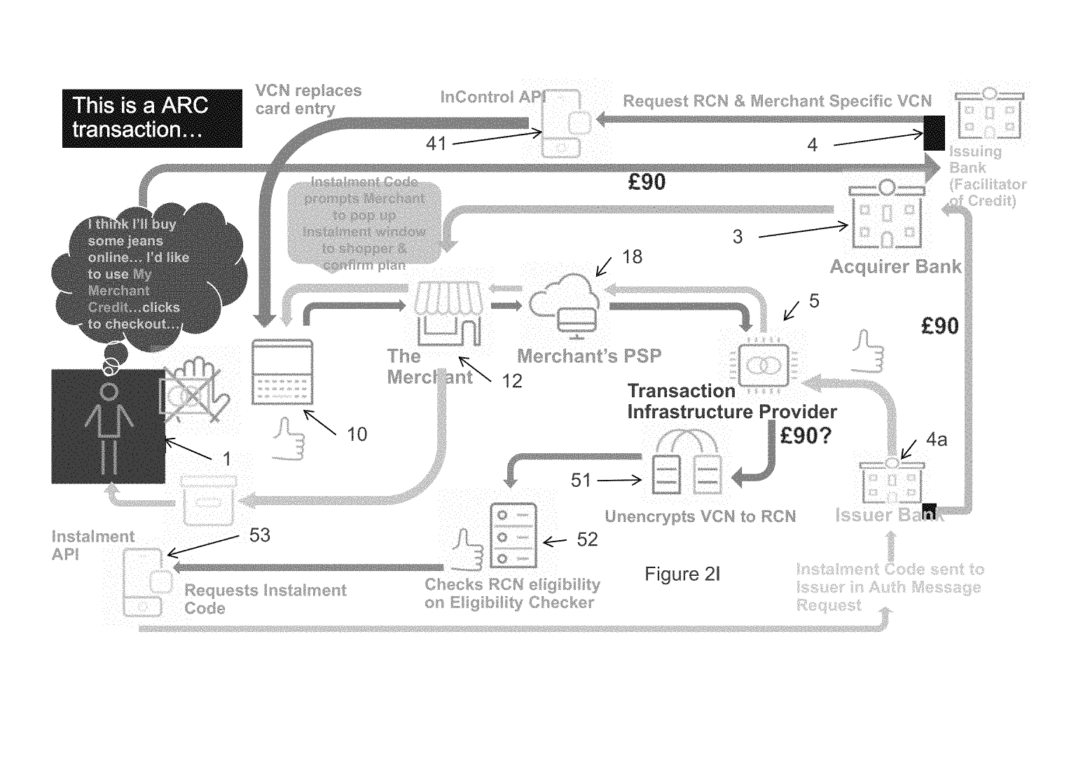

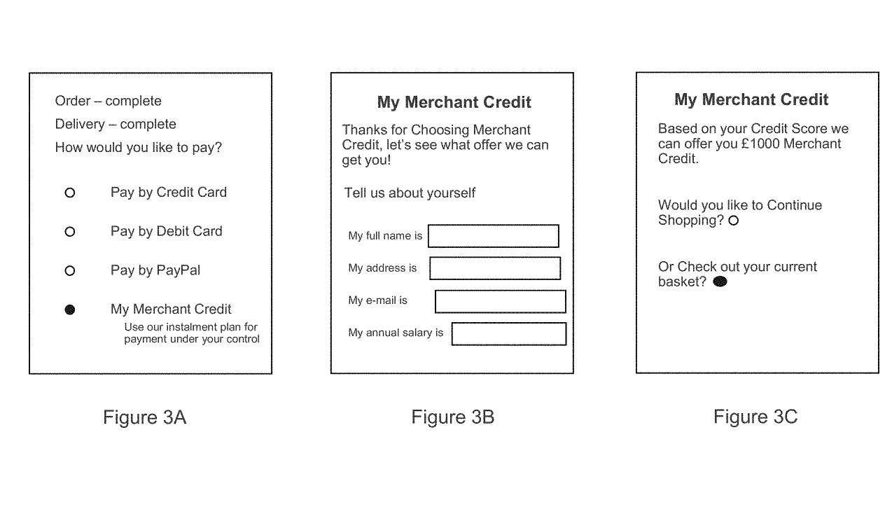

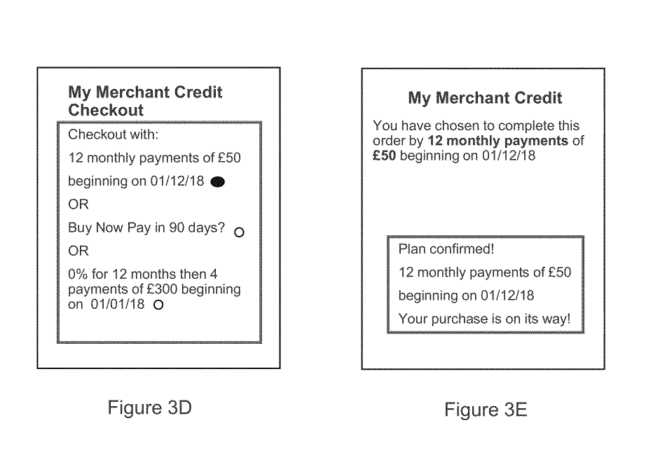

Specific embodiments of the disclosure will be described below with reference to FIGS. 2A to 2I and FIGS. 3A to 3E. This indicates an alternative transaction model (here termed an ARC transaction) implemented on a transaction infrastructure of the type shown in FIG. 6. These figures represent the elements of the infrastructure schematically. The customer has suitable computing apparatus—this may be a desktop or laptop PC 10, a tablet, or a mobile phone, or any other suitable computing device—with a network connection that allows him or her to make an online transaction. Network connections are made over the public internet or over proprietary connections as necessary—the transaction infrastructure provider 5 provides suitably programmed servers and switching to route transaction data to appropriate parties. Parties associated with the transaction infrastructure 5 (such as issuer 4 and acquirer 3) will generally be represented by servers programmed appropriately to provide the functions indicated below. The embodiment described is built over an infrastructure implementing an EMV four-party transaction scheme model. Details of EMV specifications are not provided here, but will be familiar to the person skilled in the art and can be found at https://www.emvco.com/document-search/.

FIG. 2A shows the customer's initial position—the customer 1 wishes to make an online transaction with a merchant website hosted on a merchant server 12, and has reached a checkout screen of the merchant website, as shown in FIG. 3A. In this case, the user elects not to use a conventional payment route as described in the Background above, but decides to opt for the credit option offered by the merchant, identified as “My Merchant Credit”. Using this model, the customer 1 is able to use as their payment option an instalment based plan offered by the merchant (more specifically, by a facilitator of credit on the merchant's behalf—here shown as issuing bank 4). This payment model does not rely on an existing user payment card, though as can be seen from the following description, it does involve use of an existing transaction infrastructure used by existing transaction schemes and for some parties involved in the transaction, it is not readily distinguishable from a conventional payment device purchase.

When the customer 1 takes the “My Merchant Credit” option, they are connected to a credit facilitator 4—an issuing bank, though not necessarily the issuer of any payment card owned by the customer—rather than to a conventional payment gateway 18. The customer will typically be required to enter or confirm personal information typically necessary in obtaining credit—such as salary, address and e-mail, as indicated in the exemplary screen shown in FIG. 3B—enabling the credit facilitator 4 to determine whether the customer 1 is an acceptable credit risk, and if so, how much credit can be offered. For example, in the case shown in FIG. 3C, it is determined that a credit line of up to £1000 could be offered to the customer 1. The customer 1 may decide whether to use this line of credit or take another approach to payment. The checkout process may then continue with alternative credit offers for the customer as shown in FIG. 3D, one of which could be selected.

If a credit offer is selected, the credit facilitator 4 opens a line of credit associated with the transaction with associated payment terms for the transaction corresponding to the offered instalment plan. This transaction infrastructure 5 also uses the four-party model, and as noted above the credit facilitator 4 essentially corresponds to an issuing bank. The model is directly analogous in that the credit facilitator 4 essentially establishes an account for the customer 1 for transactions with that merchant associated with a real card number (RCN) that performs a similar role to a primary account number (PAN) for a conventional payment card. Associated with the specific transaction requested there will also be a virtual card number (VCN) with use limited to the specific transaction at issue. The RCN and VCN may also be termed a real account number and a virtual account number.

If a customer 1 makes a future transaction with the same retailer and again selects “My Merchant Credit”, this credit approval step may be circumvented and the existing RCN used, with only a new VCN created for this new transaction. Potentially, the RCN may cover interactions between the credit facilitator 4 and the customer 1 involving other merchants, but the VCN will be merchant specific. The credit facilitator 4 must request any new RCN and VCN from a transaction infrastructure provider 5—in this case of the applicant, this is achieved through Mastercard's InControl product, which provides card management capabilities for issuers and can establish supplementary card creation and usage parameters.

At this point a merchant specific VCN for the transaction is created (and an RCN created if needed), and the VCN is provided as shown in FIG. 2C to the user computing device 10 for use in the transaction. The VCN is used by the user computing device 10 to complete transaction details for provision to the merchant's payment gateway 18, where the transaction is processed in exactly the same way as for a standard payment card transaction, as the VCN is recognised as a valid card number by the transaction infrastructure 5. The messaging may contain a flag indicating that the transaction relates to an instalment plan. The transaction is routed to the transaction infrastructure provider 5 for processing.

FIG. 2E shows the next step taken by the transaction infrastructure provider 5, which is to decrypt 51 the VCN—which the transaction infrastructure provider 5 recognises as being a VCN from the number used—to find the associated RCN, which may for example be done through InControl. Determination of the RCN allows determination of whether the proposed transaction is acceptable—essentially, determination of whether the customer is an acceptable credit risk—through an eligibility checker 52. In the case of an initial “My Merchant Credit” transaction, this should be straightforward, as the process of creating the RCN has established that the customer is eligible for the initial transaction. However, in the case of multiple transactions over time, it is possible that a new transaction may fail at this stage for an RCN identified as eligible for earlier transactions.

Eligibility determination is shown in FIG. 2F—if the RCN is identified as eligible for the transaction an instalment code is requested for association with the transaction, and may be provided by an appropriate service 53 represented here as an “Instalment API”. This eligibility checking step and instalment code provision may be provided by the transaction infrastructure provider 5 as shown here, or by services associated with the transaction infrastructure provider 5. When an instalment code has been received to identify that the transaction has been approved for a “My Merchant Credit” plan, this is included by the transaction infrastructure provider in the authorization message request sent to an issuer bank 4a for the transaction. This issuer bank 4a is not (or need not be) identical to the credit facilitator 4 “issuing bank” that requested the RCN and VPN(s) and which is providing credit to the customer, but there is clearly a relationship between the two as the issuer bank 4a is providing the funds for the transaction.

As shown in FIG. 2G, at this point the transaction proceeds as a conventional four-party model EMV transaction. The issuer bank 4a approves the transaction, this approval is provided to the scheme provider 5 who routes it back to the merchant 12 through the merchant's PSP 18. The receipt of the instalment code with the transaction approval data prompts the merchant 12 to provide a pop-up instalment window associated with that plan, as shown in FIG. 3E. Following this step, the goods are released to the consumer by the merchant, and settlement takes place between the issuer bank 4a and the merchant's acquirer bank 3 in standard fashion with the funds for the transaction being received in a merchant account. In the clearing process, the instalment plan may be included by the transaction infrastructure provider 5.

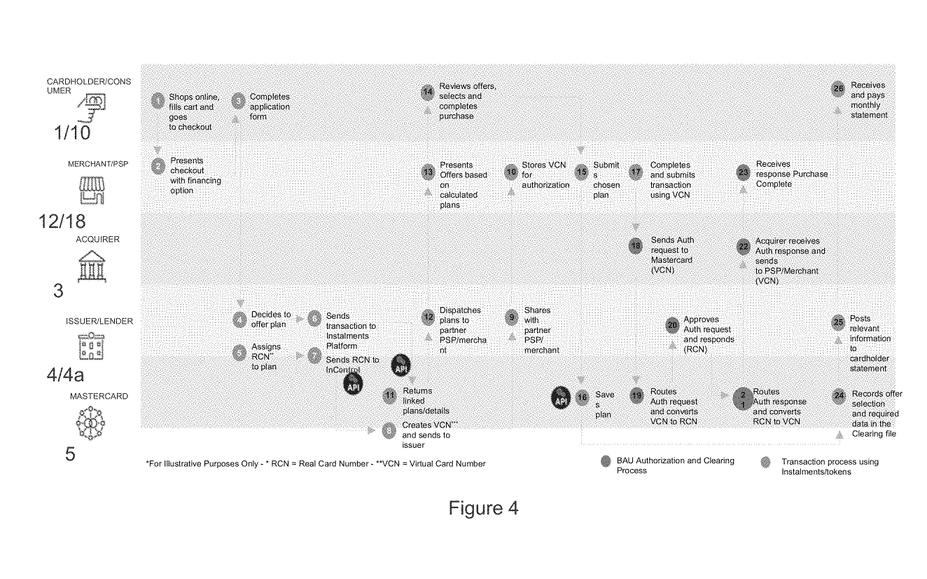

FIG. 4 shows an alternative process flow using the same infrastructural elements as shown in FIGS. 2A to 2I but with a different order of events. As before, the consumer 1 shops online using his or her computing apparatus 10 and checks out, again choosing the financing option and filling out the relevant application form. This gets passed to the credit issuing bank, which decides to offer a plan and assigns an RCN to it. At this point the transaction is sent to the instalment plan provider 53 while the RCN is provided to InControl to create a VCN for the plan. The transaction scheme provider 5 provides both created VCN and the linked plan to the credit issuer 4a. The plan is sent to the merchant PSP 18 and so to the merchant server 12 where it is presented to the consumer 1 to review the credit offer (or offers), make a selection and complete the purchase. The VCN is provided to the issuer 4a and to the merchant PSP 18, but need not be provided to the consumer—the VCN may be held by the merchant, who is in a position to match up the VCN against a selected plan.

If a credit option has been chosen, the merchant completes the plan with the stored VCN associated with that plan and sends an authorization request to the transaction scheme provider using that VCN. This is recognised as a VCN transaction as before, so it is routed for decoding of the VCN to recover the associated RCN, which is returned to the issuer for authorization of the transaction. The authorization is received by the transaction scheme provider, who converts the RCN pack to the VCN and sends authorization to the acquirer 3, who passes this back to the merchant PSP as for a conventional transaction. The merchant determines the purchase to be complete, and releases the goods for provision to the consumer.

After completion of the transaction, the transaction type is noted in transaction scheme records for clearing, and this is provided for issuer records for use in the cardholder statement. The credit transaction then appears in the cardholder monthly statement in the conventional way and will be paid off by the consumer in payment of their monthly statement.

Further variants to these process flows are possible while maintaining the principles indicated here. For example, eligibility checking may be carried out before generation of a VCN for the instalment plan—a suitable plan may be provided (via the merchant) for customer approval at this point. The VCN may then be generated after customer approval of a plan that had been determined as suitable after the eligibility check.

Whilst various exemplary embodiments of the disclosed system and method have been described above it should be understood that they have been presented for purposes of example only, and should not be taken to be limitations. The above description is not exhaustive and does not limit the disclosure to the precise form disclosed. Modifications and variations are possible in light of the above teachings or may be acquired from practicing of the disclosure, without departing from the breadth or scope of the disclosure.

1. A method of authorizing payment for an online transaction according to a credit plan using a payment scheme infrastructure, the method comprising at the payment scheme infrastructure:
receiving from a credit issuer a real account number and a virtual account number for a credit plan for a transaction;
receiving the transaction for authorization from a merchant gateway, wherein the transaction is completed for the virtual card number;
using the virtual card number to obtain or confirm authorization for the credit plan, and recovering the real account number from the virtual card number to obtain authorization of the transaction from an issuer for the real account number; wherein
the transaction is authorized if the credit plan is authorized and the transaction is authorized by the issuer for the real account number.

2. The method of claim 1, wherein the transaction further comprises an identifier in the transaction to indicate that it is associated with a credit plan, and the method further comprises using the identifier to identify the transaction as associated with a credit plan when it is received.

3. The method of claim 1, further comprising checking eligibility for credit for the real account number when processing the transaction.

4. The method of claim 3, wherein the method further comprises providing an instalment code for the credit plan after successfully checking for eligibility for credit for the real account number.

5. A method of authorizing payment for an online transaction according to a credit plan using a payment scheme infrastructure, the method comprising a credit issuer:
receiving from a customer a request for credit for a transaction together with customer information;
determining whether to offer credit to the customer, and if so, providing a real account number for the customer and creating a virtual account number for a credit plan for the transaction;
providing the virtual account number to the merchant and real account number and the virtual account number to the payment scheme infrastructure;
authorizing the transaction, if the transaction is completed using the virtual account number and the credit plan is authorized, through an issuing bank associated with the credit issuer; and
requesting payment from a customer for the transaction according to the credit plan.

6. The method of claim 5, wherein if the customer has previously requested credit from the credit issuer, the credit issuer uses the existing real account number for the customer but creates a new virtual card number for the credit plan.

7. A method of establishing and authorizing payment for an online transaction according to a credit plan using a payment scheme infrastructure, the method comprising a merchant:
at an online checkout for a transaction, receiving a customer request for a credit plan for the transaction;
causing the request for a credit plan and associated customer information to be provided to a credit issuer;
if the request for a credit plan is accepted, receiving from the credit issuer a credit plan to present to the customer and a virtual card number for the credit plan; and
if the customer accepts the credit plan, completing the transaction with the virtual card number and submitting the transaction for authorization.

8. The method of claim 7, wherein completing the transaction further comprises including an identifier in the transaction to indicate that it is associated with a credit plan.

9. The method of claim 7, wherein the transaction is completed with the virtual card number at a merchant payment gateway.

10. A payment scheme infrastructure adapted to authorize payment for an online transaction according to a credit plan, the payment scheme infrastructure being adapted to:
receive from a credit issuer a real account number and a virtual account number for a credit plan for a transaction;
on receiving a transaction for authorization from a merchant gateway completed for the virtual card number, to use the virtual card number to obtain or confirm authorization for the credit plan, and to recover the real account number from the virtual card number to obtain authorization of the transaction from an issuer for the real account number.

11. The payment scheme infrastructure of claim 10, further comprising an eligibility checker for checking eligibility for credit for the real account number when processing the transaction.

12. The payment scheme infrastructure of claim 11, wherein the eligibility checker is adapted to obtain an instalment code for the credit plan after successfully checking for eligibility for credit for the real account number.

13. A credit issuer computing system adapted for authorizing payment for an online transaction according to a credit plan using a payment scheme infrastructure, the credit issuer computing system being adapted to:
receive from a customer a request for credit for a transaction together with customer information;
determine whether to offer credit to the customer, and if so, provide a real account number for the customer and create a virtual account number for a credit plan for the transaction;
provide the virtual account number to the merchant and real account number and the virtual account number to the payment scheme infrastructure;
authorize the transaction, if the transaction is completed using the virtual account number and the credit plan is authorized, through an issuing bank associated with the credit issuer; and
request payment from a customer for the transaction according to the credit plan.

14. The credit issuer computing system of claim 13, wherein if the customer has previously requested credit from the credit issuer, the credit issuer computing system is adapted to use the existing real account number for the customer but to create a new virtual card number for the credit plan.
